(19) United States
(12) Patent Application Publication
(10) Pub. No.: US 2025/0112003 A1
(43) Pub. Date: Apr. 3, 2025

(54) Integral Interface Seal

(71) Applicant: ABB Schweiz AG, Baden (CH)

(72) Inventors: Matthew D. Cawood, DeLeon Springs, FL (US); Jorge F. Vigo, South Daytona, FL (US)

(73) Assignee: ABB Schweiz AG, Baden (CH)

(21) Appl. No.: 18/476,829

(22) Filed: Sep. 28, 2023

(51) Int. Cl. H01H 9/04; F16J 15/10

(52) U.S. Cl. CPC H01H 9/04; F16J 15/104

(57) ABSTRACT

An integrally formed interface seal, including a base including a sidewall configured to surround at least a portion of a disconnector switch housing configured to house an interface pad, a first lip extending inward relative to the sidewall, and a second lip from the first lip and away from the first lip parallel to the sidewall. The second lip is configured to be compressed against the disconnector switch housing to hermetically seal a conductor secured to the interface pad from an external environment.

### FIELD

The present disclosure relates to an integral interface seal, a method for producing an integral interface seal, and a method for sealing an interface of a conductor with a disconnector switch.

### BACKGROUND OF THE INVENTION

Disconnect switches are often used to provide isolation and safety when work is being performed on an electrical network and/or system. The disconnect switches are used to protect maintenance crew members by avoiding exposing them to live components. In addition, disconnect switches can be self-contained and provide a single point at which electrical isolation can be ensured, thereby more readily providing for maintenance to be performed. One disadvantage of disconnect switches, however, is in how they are interfaced with electrical networks in which they are employed. For example, some disconnect switches are installed in a subterranean or submersible environment, and must have conductor interfaces that are sealed from the environment to prevent corrosion of conductors and/or electrical losses. One known solution is to use mastic and electrical tape suitable for water-tight sealing. The tape is wrapped tightly around the interface at which one or more conductors of the electrical network connects to the disconnect switch. The use of tape is common in part because it is very flexible, both in terms of material/shape flexibility and flexibility of application. For example, tape can conform to a variety of interface shapes that may vary due to the size and shape of a conductor interfaced to the disconnector switch. Furthermore, the use of tape provides for variable layering depending on the needs of the particular installation, as some installation sites may require less tape (e.g., a site in an already controlled environment) than other sites where pressure and/or environmental concerns may necessitate many layers of tape to be used.

However, the use of tape to form proper seals at the disconnector switch interface is time-consuming and requires skilled labor. In some instances, it may take 45 minutes or more to complete a disconnector switch installation due to the time required to tape a proper seal about the interface. In addition, the use of tape inevitably leads to variable interface seal quality between interfaces of a single disconnector switch or between the interfaces of separate disconnector switches, which may lead to variable interface seal life and less predictable maintenance and/or inspection timelines. In addition to increased installation times, the use of tape also necessitates use of many rolls of tape, thus burdening crew members responsible for obtaining, storing, and transporting the tape, as well as occupying space at the installation site itself.

### BRIEF SUMMARY OF THE INVENTION

In an embodiment, the present disclosure provides an integrally formed interface seal, comprising a base including a sidewall configured to surround at least a portion of a disconnector switch housing configured to house an interface pad, a first lip extending inward relative to the sidewall, and a second lip from the first lip and away from the first lip parallel to the sidewall. The second lip is configured to be compressed against the disconnector switch housing to hermetically seal a conductor secured to the interface pad from an external environment.

### BRIEF DESCRIPTION OF THE SEVERAL VIEWS OF THE DRAWINGS

Subject matter of the present disclosure will be described in even greater detail below based on the exemplary figures. All features described and/or illustrated herein can be used alone or combined in different combinations. The features and advantages of various implementations will become apparent by reading the following detailed description with reference to the attached drawings, which illustrate the following:

FIG. 1A illustrates a plurality of disconnector switches;

FIG. 1B illustrates a perspective view of a disconnector switch with an exposed interface pad;

FIG. 2A illustrates a cross-sectional view of a conductor interfaced and sealed to an interface pad with an interface seal according to an embodiment of the present disclosure;

FIG. 2B illustrates a close-up cross-sectional view of the interface seal of FIG. 2A;

FIG. 3 illustrates a cross-sectional view of an interface seal according to an embodiment of the present disclosure;

FIG. 4A illustrates a partial perspective view of an interface seal according to an embodiment of the present disclosure;

FIG. 4B illustrates a top and partial cross-sectional view of the interface seal of FIG. 4A;

FIGS. 5A-5C illustrate interface seals according to embodiments of the present disclosure;

FIG. 6 illustrates a partial cross-sectional view of an interface seal and an interface pad according to an embodiment of the present disclosure;

FIG. 7 illustrates conductor-side interface plates according to embodiments of the present disclosure; and

FIGS. 8A-8B illustrate seal plugs according to an embodiment of the present disclosure.

### DETAILED DESCRIPTION OF THE INVENTION

In an embodiment, the present invention provides a disconnector switch interface seal that eliminates the need for tape to be used in forming a water-tight and/or environment-proof seal at the interface of a disconnector switch with a conductor. The seal can be prefabricated in a highly customized manner so that a device-specific seal can be formed. The seal thereby allows a high degree of flexibility and customizability. The seal also significantly reduces installation time required to attach and seal a conductor to a disconnector switch, in some embodiments requiring less than 5 minutes to connect and seal an interface. The seal is also integrally formed and has a unitary construction, reducing the need for sealing interfaces between components and significantly reducing installation complexity by reducing the quantity of required components.

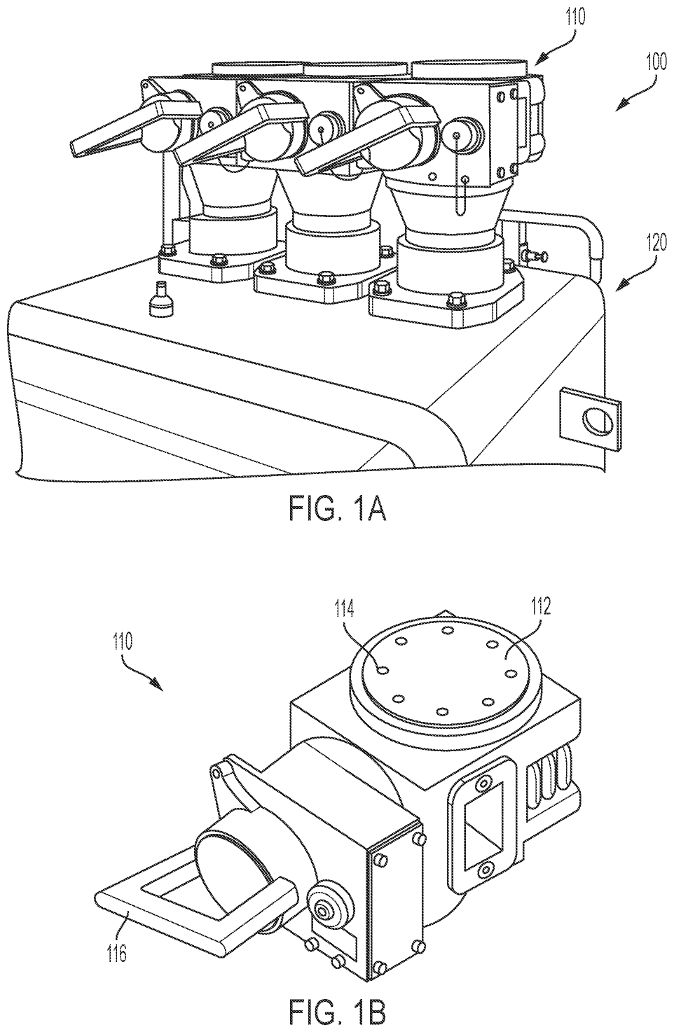

FIG. 1A illustrates a plurality of disconnector switches 110 mounted on a disconnector housing 120 as part of a disconnector switch assembly 100. The disconnector switches 110 allow for connecting/interfacing of conductors onto the disconnector switch assembly 100. The individual disconnector switches 110 each provide means for electrically disconnecting attached conductors from the disconnector switch assembly 100, thereby electrically isolating the attached conductor from electrical components on the opposing end of the disconnector switch 110. Although the disconnector switches 110 in the illustrated embodiment are attached to a disconnector switch assembly 100, the disconnector switches 110 may also be used individually and mounted to any surface to connect two conductors to one another, thereby providing the capability of disconnecting the conductors.

FIG. 1B illustrates a perspective view of an individual disconnector switch 110 with an exposed interface pad 112. The interface pad 112 is configured for a high degree of compatibility with conductors so that a variety of conductors can be properly secured to and connected to the interface pad 112. The interface pad includes a plurality of openings 114 configured to receive fasteners used to press a conductor against the interface pad 112 and keep it electrically connected in a secure and reliable manner. In an embodiment, the openings 114 may be threaded openings configured to receive correspondingly threaded bolts.

The disconnector switch 110 also includes a handle 116, which a user may grip, turn, and pull in order to electrically isolate one side of the disconnector switch 110 from the other side, thereby electrically disconnecting one conductor on one side of the disconnector switch 110 from a conductor that is attached to the interface pad 112. In an embodiment, the handle 116 may be connected to a conducting rod configured to electrically connect the interface pad 112 to another conductor of the disconnector switch 110, thereby disconnecting the same when the handle 116 is pulled and the conducting rod is removed from within the disconnector switch 110. In an embodiment, the conducting rod may be configured for a 3500 Amp continuous rating. In an embodiment, the disconnector switch 110 may be embodied as a commercially available disconnector switch. In an embodiment, the disconnector switch 110 may be the VisoBlock™ disconnector switch by Eaton®.

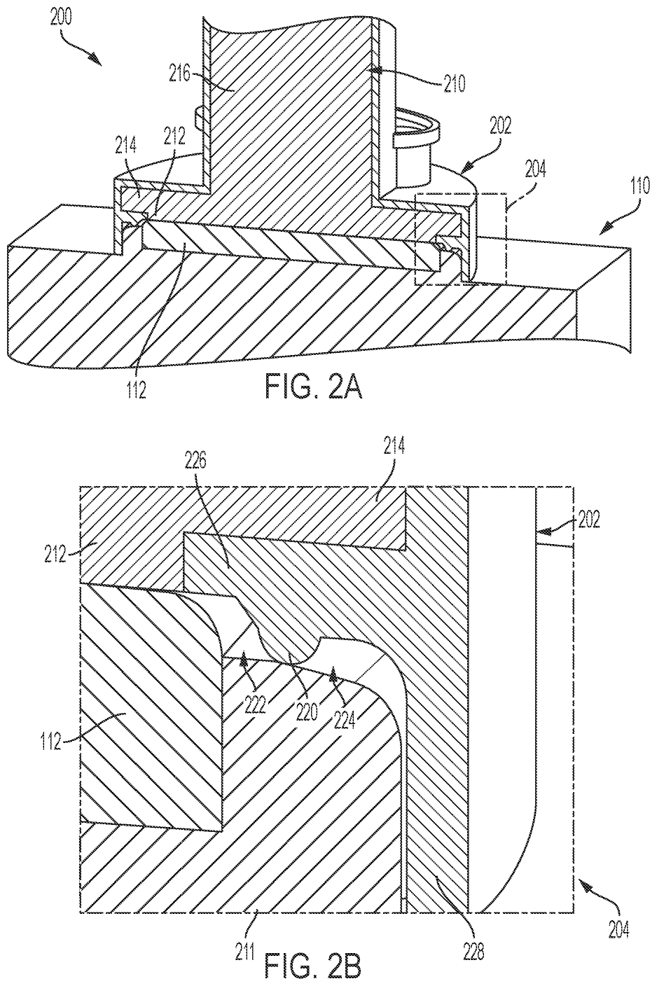

FIG. 2A illustrates a cross-sectional view of sealed interface 200 according to an embodiment of the present disclosure in which a conductor 210 is interfaced and sealed to an interface pad 112 of a disconnector switch 110. The conductor 210 includes a conductor shaft 216 and a conductor interface plate 214. The conductor interface plate 214 includes a conductor interface pad 212 configured to contact the interface pad 112 of the disconnector switch 110, thereby providing a reliable electrical connection between the aforementioned components. In the illustrated embodiment, the conductor 210 comprises a single unitary conductor, with the conductor shaft 216, the conductor interface plate 214, and the conductor interface pad 212 forming portions of the unitary conductor. In some embodiments, the conductor shaft 216, the conductor interface plate 214, and/or the conductor interface pad 212 may comprise physically separate and distinct structures that may be arranged/assembled together to form a conductor having a similar shape to that of the conductor 210 of FIG. 2A.

The sealed interface 200 also includes an interface seal 202 configured to surround the conductor 210, an exposed surface of the interface pad 112, and a portion of the housing of the disconnector switch 110, thereby forming a hermetic seal that protects the conductor and interface pad from corrosion. The interface seal 202 also electrically insulates the conductor 210 from the environment, thereby preventing electrical leaks or shorting. A section 204 of the sealed interface 200 is also illustrated, which forms the basis for FIG. 2B.

FIG. 2B illustrates a close-up cross-sectional view of the sealed interface 200 of FIG. 2A, and in particular the section 204. The interface seal 202 includes a sidewall 228 configured to extend along a surface of a housing 211 of the disconnector switch 110 and along a periphery of the conductor interface plate 214. In the illustrated embodiment, the sidewall 228 is configured as a contiguous vertical wall extending along the entire height of the housing 211 and the conductor interface plate 214 when the conductor 210 (via conductor interface pad 212) is secured to the interface pad 212. The interface seal 202 also includes a first lip 226 extending away from the sidewall 228 and a second lip 220 extending away from the first lip 226 and arranged adjacent a corner formed by the first lip 226 and the sidewall 228. In other words, the first lip 226 extends radially inward relative to the sidewall 228, which extends in an axial direction of the interface seal 202, and the second lip 220 extends axially away from the first lip 226 in a manner parallel to the sidewall 228 and offset radially inward relative to the sidewall 228.

The first lip 226 is configured to abut both a radial periphery of the conductor interface pad 212 and an axial periphery of the conductor interface plate 214. In the illustrated embodiment, because the conductor interface pad 212 and the conductor interface plate 214 form a right angle corner, the first lip 226 is formed with a corresponding right angle corner configured to abut against, cover, and seal the peripheries of the conductor interface pad 212 and conductor interface plate 214 that would otherwise be exposed. In some embodiments, the conductor interface pad 212 and conductor interface plate 214 may form varying shapes, such as non-right angle corners, rounded corners, chamfers, and the like. It will be readily appreciated that in such embodiments, the first lip 226 may be formed to fill space formed by exposed portions of the conductor interface pad 212 and conductor interface plate 214 when the conductor 210 is connected to the interface pad 112 of the disconnector switch, regardless of the particular shape, without departing from the spirit of the present invention.

The second lip 220 is configured to extend away from the first lip 226, away from the conductor interface plate 214, and toward the housing 211 of the disconnector switch. In so doing, the second lip 220 is configured to abut the housing 211 of the disconnector switch to form a first seal of the conductor interface plate, conductor interface pad 212, and interface pad 112 from an external environment. A second seal of the same components, as well as the first seal and the second lip 220, is formed by abutment of the sidewall 228 against the housing 211 of the disconnector switch. In some embodiments, the first seal forms a stronger primary seal, while the second seal forms a secondary and weaker seal primary meant to prevent debris from entering into a space within the interface seal 202.

When the sealed interface 200 is fully assembled, the second lip 220 is configured to be compressed against the housing 211 of the disconnector switch. That is, the uncompressed axial length of the first lip 226 and second lip 220 extending between the conductor interface plate 214 and the housing 211 of the disconnector switch is greater than the distance between the conductor interface plate 214 and the housing 211 when the conductor interface pad 212 is fully secured to the interface pad 112. The interface seal 202 is also configured to provide a first expansion space and a second expansion space 224 on either side adjacent the second lip 220. The first and second expansion spaces 222, 224 provide physical space for the lateral expansion of the second lip 220 upon compression of the second lip 220. It has been found that the first and second expansion spaces 222, 224 are important to ensure that the second lip 220 can be compressed sufficiently, and therefore to expand sufficiently laterally (or, in reference to a central axis of the interface seal 202, radially), to form a sufficiently strong seal against housing 211 of the disconnector switch. If first or second expansion space 222, 224 is not included or is too small, the compression of the second lip 220 may cause elastic deformation of the first lip 226 and/or the sidewall 228 such that flush seals against the conductor interface plate 214, conductor interface pad 212, and/or housing 211 are not properly formed, thereby compromising the sealing strength of the interface seal 202 and potentially reducing pressure-sealing and/or protective sealing capabilities of the seal interface 200 as a whole.

In some embodiments, the second lip 220 has a nominal cross-sectional width of 1/16 to one quarter inch. In some embodiments, the second lip 220 has an actual cross-sectional width of 0.070 to 0.275 inches, and is configured for a gland depth of 0.05 to 0.229 inches. The second lip 220 is configured to be squeezed to form a seal, and may therefore be configured for an actual squeeze of 0.015 to 0.055 inches or a percentage squeeze of between 15 to 32%. In an embodiment, the second lip 220 is configured to be squeezed by 0.05 inches.

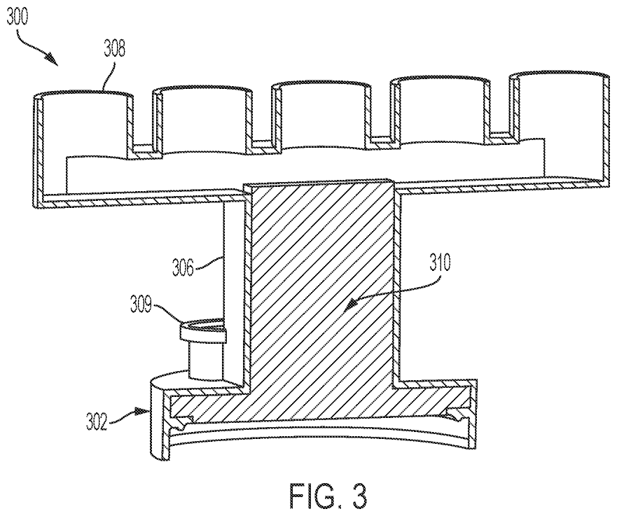

FIG. 3 illustrates a cross-sectional view of an assembly 300 including an interface seal 302 according to an embodiment of the present disclosure. The interface seal 302 is configured to surround and encase a conductor 310. The interface seal 302 includes a seal shaft 306 configured to surround and encase a corresponding shaft or column of the conductor 310. The interface seal 302 also includes one or more bolt interfaces 309 near a base extending axially from the base of the seal shaft 306 and away from a portion base of the interface seal 302 configured to surround the conductor interface plate and conductor interface pad of the conductor 310. A plurality of conductor connection openings 308 are also included at an end (in the illustrated embodiment, the top end) of the interface seal 302. The conductor connection openings 308 allow the conductor 310 within the interface seal 302 to be electrically split via electrical connection to a plurality of further external conductors. The seal shaft 306 also provides a transitional region of the interface seal 302 whereby space may be provided above the one or more bolt interfaces 309 for inserting and tightening bolts. If the seal shaft 306 does not have a sufficient height (e.g., if the conductor connection openings 308 are too close to the one or more bolt interfaces 309, then insertion and tightening of bolts through the one or more bolt interfaces 309 may become difficult or even impossible.

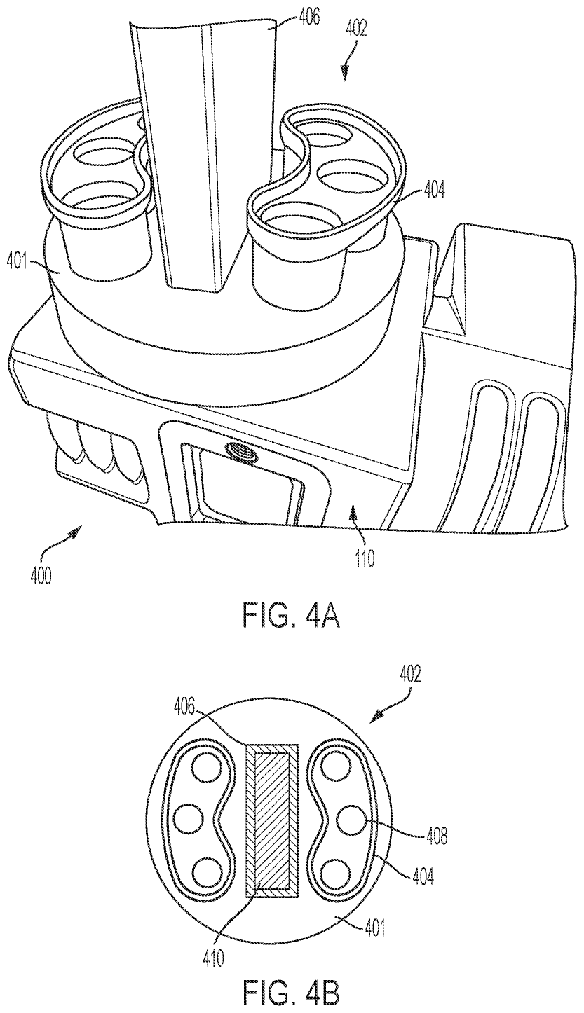

FIG. 4A illustrates a partial perspective view of an assembly 400 with an interface seal 402 according to an embodiment of the present disclosure. The interface seal 402 is arranged on a disconnector switch 110. The interface seal 402 includes a base 401. Two bolt interfaces 404 and a seal shaft 406 extend from the base 401 away from the disconnector switch 110. Each bolt interface 404 includes three openings for receiving bolts, as will be described hereafter with reference to FIG. 4B.

FIG. 4B illustrates a top and partial cross-sectional view of the interface seal 402 of FIG. 4A. Each bolt interface includes three bolt openings 408 for receiving bolts. In the illustrated embodiment, three bolt openings 408 are provided on opposing sides of the base 401 relative to one another, thereby allowing six bolts to be inserted through the interface seal 402 to tightly secure a conductor 410 onto an interface pad of the disconnector switch 110. It will be readily appreciated that the number and precise position of the bolt openings 408 may vary according to the particular needs of a conductor and/or an installation of a disconnector switch without departing from the spirit of the present invention. For example, fewer bolts may be required in applications where a conductor interface needs to be sealed from dust and debris, but does not necessarily require a water-tight seal. In some embodiments more than a total of six bolts and corresponding bolt openings may be used. Bolts inserted through the bolt openings only directly tighten a conductor against an interface pad of the disconnector switch 110, but in so doing also indirectly compress portions of the interface seal 402 against the disconnector switch, for example as described above with reference to FIG. 2B. The bolt openings 408 are arranged in a symmetrical manner relative to the seal shaft 406. The bolt openings 408 are configured and arranged to provide an evenly distributed tightening force of a conductor against an interface pad of the disconnector switch 110. The seal shaft 406 is configured to surround and encase a conductor 410 having a rectangular cross-section.

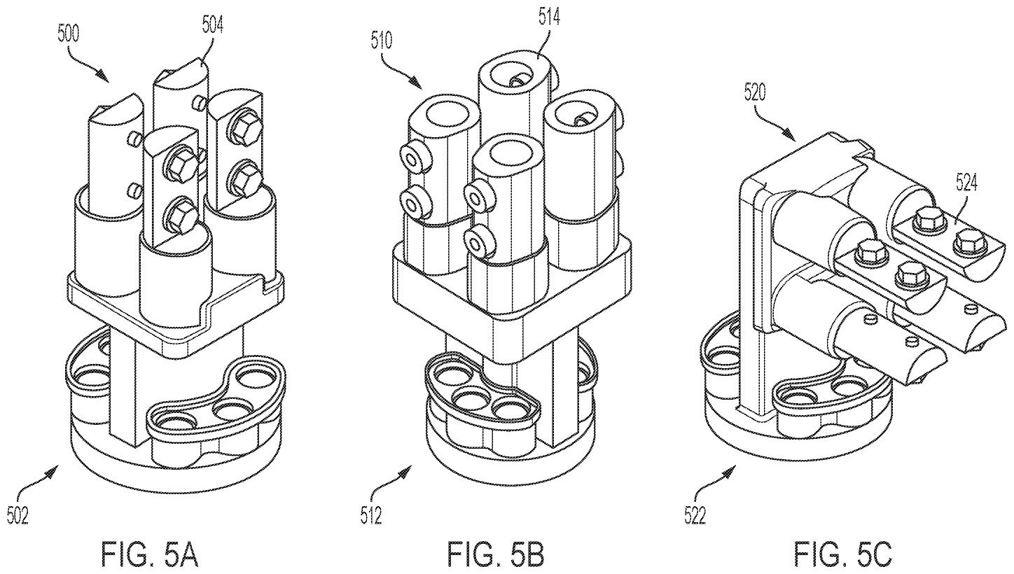

FIGS. 5A-5C illustrate interface seals according to embodiments of the present disclosure. Specifically, FIG. 5A illustrates a first seal interface assembly 500 with a first interface seal 502 configured to seal a first conductor 504. The first conductor 504 includes a plurality of semi-cylindrical rods providing an interface by which further conductors may be secured. FIG. 5B illustrates a second seal interface assembly 510 with a second interface seal 512 configured to seal a second conductor 514. The second conductor 514 include hollowed rods providing an interface by which further conductors may be secured. The seal shaft of the interface seal 512 may have a non-rectangular cross section (e.g., a cross-section that is generally rectangular but includes a circular portion interrupting one or more sides of the rectangle). The bolt interface of the interface seal 512 may abut the seal shaft. FIG. 5C illustrates a third seal interface assembly 520 with a third interface seal 522 configured to seal a third conductor 524. Unlike the embodiments of FIGS. 5A and 5B, the third conductor 524 may include protrusions that extend laterally (e.g., in a radial direction relative to an axis extending orthogonal to a center of the circular base of the conductor where it interfaces with an interface pad of a disconnector switch. In the illustrated embodiment, the third conductor 524 includes semi-cylindrical protrusions configured similar to those of FIG. 5A.

FIGS. 5A-5C illustrate the versatility of the interface seal 502, 512, 522 in adapting to a variety of conductor shapes and nonetheless providing for proper sealing of the conductor where it interfaces with a disconnector switch. In a method for forming an interface seal, a volume of liquid polyvinyl chloride (PVC) is provided. The conductor intended to be sealed is dipped into the volume of liquid PVC and the conductor is heated to approximately 350 degrees Celsius. The heated conductor causes the liquid PVC to vulcanize, thereby producing a solid vulcanized mass surrounding the conductor. In some embodiments, this process is carried out in just five minutes. It will be readily appreciated that the time period over which vulcanization occurs can be adjusted depending on the needs of a particular conductor and/or interface and/or application. For example, if a particular application requires a thicker interface seal, the vulcanization process can be carried out over a longer period of time (e.g., up to ten minutes or more). After the vulcanization process is ended/completed, in some embodiments a post-processing operation may optionally be carried out. The post-processing operation may include curing the vulcanized mass in an oven and/or cutting, drilling, and/or machining the vulcanized mass in order to create openings (e.g., bolt openings, an opening for the conductor interface pad, etc.) and form a finalized interface seal. Because the conductor itself is used to form the interface seal via vulcanization, the interface seal is configured precisely to conform to the shape of the particular conductor dipped and heated in the liquid PVC. Features of the interface seal that do not directly contact the dipped conductor during the molding process (e.g., the second lip 220 and first and second expansion spaces 222, 224, as illustrated in FIG. 2B) are formed by a tooling plate that includes an outline or peripheral surface corresponding to those features. Furthermore, the foregoing steps allow for a single integral seal of a unitary construction to be formed, thus eliminating the need for layering to form a stronger seal, significantly simplifying an installation process, and significantly reducing the time and skill required to complete a proper installation of a conductor to a disconnector switch.

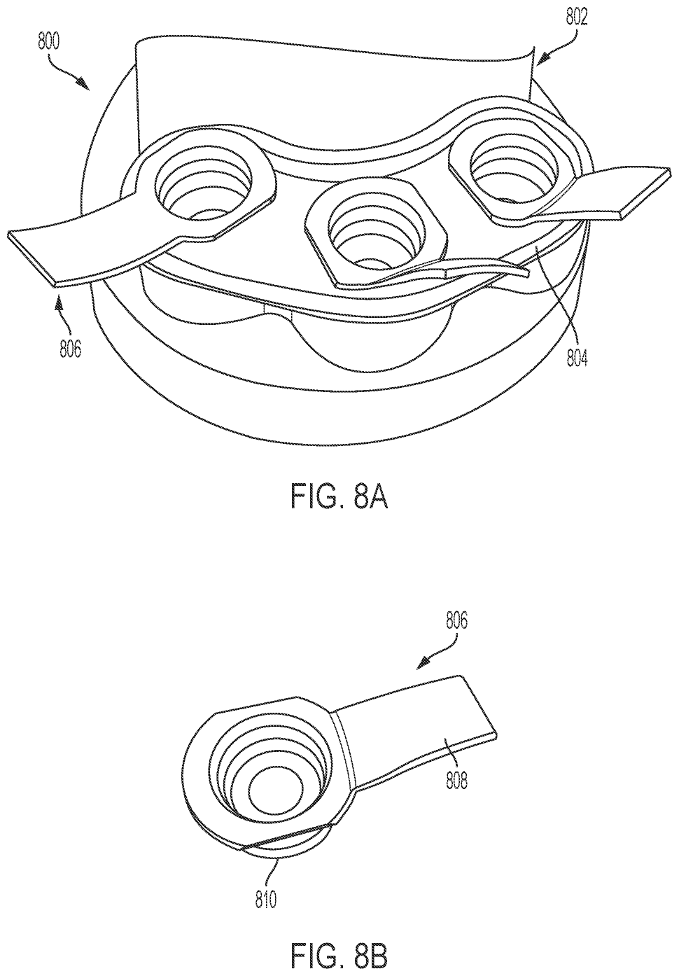

In an embodiment, a method for sealing an interface of a conductor with a disconnector switch is provided. The method includes providing a conductor that is to be sealed to a disconnector switch. A volume of liquid PVC is then provided and the steps for producing an interface seal as described above are carried out. After post-processing and/or cooling, the conductor is secured to an interface pad of a disconnector switch by inserting and tightening bolts through bolt openings of the interface seal. The bolts are tightened until the interface seal forms a seal sufficient to seal the conductor interface plate and conductor interface pad of the conductor, as well as the interface pad of the disconnector switch, from an external environment (e.g., by compression of a second lip of the interface seal as described above with reference to FIG. 2B). Each of a plurality of seal plugs (as will be described hereafter with reference to FIGS. 8A and 8B) are then inserted into a bolt opening until all bolt openings are sealed such that all inserted and tightened bolts are also sealed from the external environment.

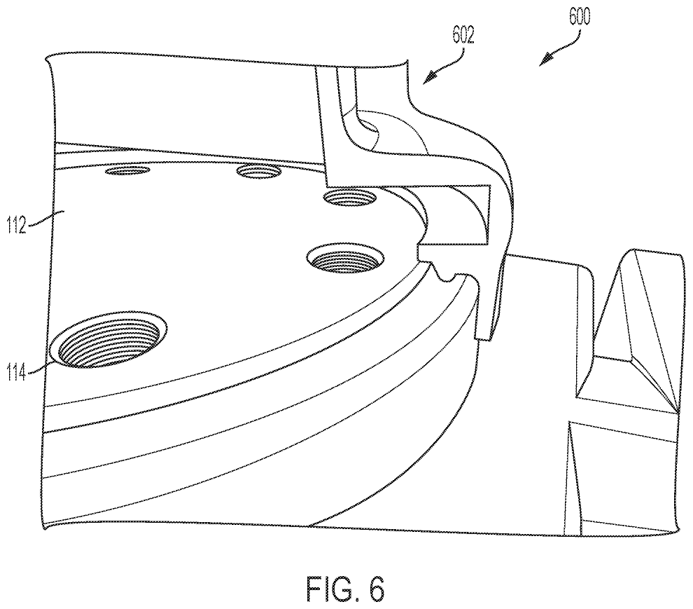

FIG. 6 illustrates a partial cross-sectional view of an assembly 600 including an interface seal 602 and an interface plate 112 of a disconnector switch according to an embodiment of the present disclosure. The interface pad 112 of the disconnector switch includes a plurality of openings 114 that are threaded and configured to receive bolts. The openings 114 are evenly distributed relative to one another in a circular patter about a center of the interface pad 112. The interface seal 602 is shown in cross-section in order to illustrate how a hollow interior of the interface seal 602 accommodates a conductor, together with a conductor interface plate and conductor interface pad of the conductor.

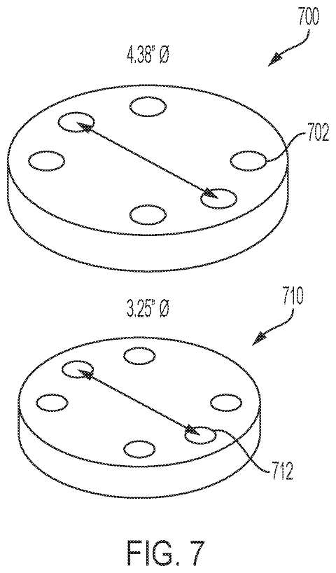

FIG. 7 illustrates conductor interface plates 700, 710 according to embodiments of the present disclosure. In an embodiment, a first conductor interface plate 700 includes a plurality of bolt openings 702 arranged symmetrically across a reference line evenly bisecting the conductor interface plate 700. The plurality of bolt openings 702 are arranged such that bolt openings 702 arranged radially opposite one another with reference to a center of the conductor interface pad are 4.38 inches apart, measured relative to the center of each bolt opening 702. In an embodiment, a second conductor interface plate 710 includes a plurality of bolt openings 712. The bolt openings are distributed and arranged similar to those of first conductor interface plate 700, but with a smaller distance between oppositely radially arranged bolt openings 712 of approximately 3.25 inches. It will be readily appreciated that although the foregoing dimensional attributes account for many commonly interfaced conductors in terms of compatibility with an interface pad of a disconnector switch, that the particular number and dimensions of a conductor interface plate may vary according to specific needs and/or applications without departing from the spirit of the present invention. For example, mote bolt openings 702, 712 may be included and evenly distributed about the entire circumference of the conductor interface plates 700, 710 in some embodiments.

FIGS. 8A-8B illustrate seal plugs 806 according to an embodiment of the present disclosure. Specifically, FIG. 8A illustrates an interface seal assembly 800 including an interface seal 802 with a plurality of seal plugs 806 inserted into bolt openings of a bolt interface 804 of the interface seal 802. The seal plugs 806 are configured to fit into the bolt openings via interference fit and ensure that a desired sealing effect of the interface seal 802 is maintained. The seal plugs 806 are inserted into the bolt openings after bolts have already been inserted and tightened to secure a conductor to a disconnector switch, thereby also securing the interface seal to both of the foregoing and form a seal interface. As illustrated in FIG. 8B, each seal plug 806 includes a cylindrical plug 810 configured to be inserted and seal off bolt openings of the interface seal 802, as well as a pull tab 808. The pull tab 806 has sufficient structural rigidity to withstand an entire force necessary to dislodge a seal plug 806 from a bolt opening.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An integrally formed interface seal, comprising:
a base including a sidewall configured to surround at least a portion of a disconnector switch housing configured to house an interface pad;
a first lip extending inward relative to the sidewall; and
a second lip from the first lip and away from the first lip parallel to the sidewall,
wherein the second lip is configured to be compressed against the disconnector switch housing to hermetically seal a conductor secured to the interface pad from an external environment.

2. The interface seal of claim 1, further comprising at least two bolt interfaces extending away from the base, each of the at least two bolt interfaces including a plurality of bolt openings, and wherein the bolt openings are each configured to receive a bolt configured to secure the conductor to the interface pad.

3. The interface seal of claim 2, further comprising a seal shaft extending away from the base and configured to encase a corresponding shaft of the conductor, the seal shaft having a height from the base greater than a height of the bolt interfaces from the base.

4. The interface seal of claim 1, wherein the sidewall and the disconnector switch housing are cylindrical, part of the sidewall being configured to abut and surround a periphery of the disconnector switch housing.

5. The interface seal of claim 1, wherein the first lip is orthogonal to the sidewall.

6. The interface seal of claim 1, wherein the first lip is rectangular in cross section and is configured to fill a corresponding rectangular corner formed by the conductor.

7. The interface seal of claim 1, wherein the second lip is semi-circular in cross section and configured to compress laterally into first and second expansion spaces adjacent the second lip.

8. A system comprising:
a disconnector switch including a housing for at least partially housing an interface pad;
a conductor configured to be secured to the disconnector switch via the interface pad; and
an interface seal configured to surround and seal the interface pad of the disconnector switch and at least part of the conductor secured to the interface pad from an external environment.

9. The system of claim 8, wherein the interface seal includes a plurality of threaded openings, and wherein the conductor is configured to be secured to the interface pad of the disconnector switch with a plurality of bolts, each bolt configured to mate with one of the plurality of threaded openings.

10. The system of claim 9, wherein the conductor includes a conductor interface plate and a conductor interface pad, the conductor interface pad configured to abut the interface pad of the disconnector switch and the conductor interface plate having bolt openings each configured to receive one of the plurality of bolts.

11. The system of claim 8, wherein the interface seal includes at least two bolt interfaces, each bolt interface having a plurality of bolt openings for receiving the bolts.

12. A method for sealing a conductor to a disconnector switch, comprising:
providing a volume of liquid polyvinyl chloride (PVC);
at least partially submerging a conductor into the volume of liquid PVC;
heating the conductor such that the liquid PVC surrounding submerged portions of the conductor are vulcanized to form an interface seal; and
securing the conductor to an interface pad of a disconnector switch.

13. The method of claim 12, wherein the conductor is heated to at least 350 degrees Celsius.

14. The method of claim 12, wherein the interface seal includes a plurality of bolt openings and the interface pad of the disconnector switch includes a plurality of threaded openings, and wherein the method further comprises:
inserting the bolts into the plurality of bolt openings; and
tightening the bolts in the threaded openings to secure the conductor to the interface pad and to compress a lip of the interface seal between the conductor and the disconnector switch.

15. The method of claim 14, further comprising inserting a plug into each of the bolt openings of the interface seal to seal the bolts from the external environment.
